(19) United States
(12) Patent Application Publication
(10) Pub. No.: US 2026/0300293 A1
(43) Pub. Date: Oct. 1, 2026

(54) VECTOR RETRIEVAL METHOD BASED ON PROXIMITY GRAPH AND DEVICE THEREOF

(71) Applicant: Hangzhou Dianzi University, Hangzhou City (CN)

(72) Inventors: Xiaoliang XU, Hangzhou City (CN); Can LI, Hangzhou City (CN)

(21) Appl. No.: 19/273,482

(22) Filed: Jul. 18, 2025

(30) Foreign Application Priority Data
Apr. 1, 2025 (CN) 202510397237.6

(51) Int. Cl. G06F 16/2453

(52) U.S. Cl. CPC G06F 16/24542

(57) ABSTRACT

A vector retrieval method based on a proximity graph is provided, which includes: determining a hubness degree of each vector in a whole vector data set by using an integral function of non-centrality chi-square distribution according to a vector data set; and obtaining hubness degree set H′ according to hubness degrees of all vectors; constructing proximity graph G′ by using a method of incrementally adding vectors according to similarity distances between vectors in the vector data set and the hubness degree set H′; performing vector hubness degree traversal calculation for the proximity graph G′; performing a pruning operation on the proximity graph based on the hubness degree set H to obtain a final result proximity graph G; performing search on the final result proximity graph G by using a feature vector of a query object as a query vector, to obtain a vector retrieval result.

### CROSS-REFERENCE TO RELATED PRESENT DISCLOSURE

This patent application claims the benefit and priority of Chinese Patent Application No. 2025103972376 filed with the China National Intellectual Property Administration on Apr. 1, 2025, the disclosure of which is incorporated by reference herein in its entirety as part of the application.

### TECHNICAL FIELD

The present disclosure relates to the field of vector retrieval, and in particular to a vector retrieval method based on a proximity graph and a device thereof.

### BACKGROUND

With the development of the artificial intelligence technology, the vector retrieval technology has been applied to the fields such as information retrieval and retrieval-augmented generation (RAG) to deal with the task of searching massive unstructured data such as pictures and texts. As the best solution to solve the task of searching vector data at present, the vector retrieval technology based on a proximity graph has become a research hotspot in academia and industry.

However, the vector space itself has a distance concentration effect, that is, the higher the dimension, the more concentrated the distance distribution between vectors will be. This phenomenon will significantly affect the effectiveness of the step of selecting neighbor sets in the current mainstream proximity graph construction algorithm, thus affecting the navigation precision of the resulting proximity graph.

Therefore, in order to solve the above problems, it is urgent to provide a new vector retrieval method based on a proximity graph.

### SUMMARY

The purpose of the present disclosure is to provide a vector retrieval method based on a proximity graph and a device thereof, which can improve the precision and efficiency of vector retrieval in a specific scene.

In order to achieve the above purpose, the present disclosure provides the following scheme.

In a first aspect, the present disclosure provides a vector retrieval method based on a proximity graph, wherein the vector retrieval method based on the proximity graph includes:
determining a hubness degree of each vector in a whole vector data set by using an integral function of non-centrality chi-square distribution according to a vector data set; and obtaining a hubness degree set H′ according to the hubness degrees of all vectors; where the vector data set is

$${V}_{d}^{n} = ( {v}_{1} , {v}_{2} , … , {v}_{n} ) ,$$

where n is the number of vectors, and d is the vector dimension;
constructing a proximity graph G′ by using a method of incrementally adding vectors according to similarity distances between vectors in the vector data set and the hubness degree set H′;
performing vector hubness degree traversal calculation for the proximity graph G′ to obtain an updated hubness degree set H of all vectors;
performing a pruning operation on the proximity graph G′ based on the updated hubness degree set H of all vectors to obtain a final result proximity graph G;
performing search on the final result proximity graph G by using a feature vector of a query object as a query vector, to obtain a vector retrieval result.

In a second aspect, the present disclosure provides a vector retrieval device based on a proximity graph, where the vector retrieval device based on the proximity graph includes:
a hubness degree determining module, which is configured to determine a hubness degree of each vector in a whole vector data set by using an integral function of non-centrality chi-square distribution according to a vector data set; and obtain a hubness degree set H′ according to hubness degrees of all vectors; where the vector data set is

$${V}_{d}^{n} = ( {v}_{1} , {v}_{2} , … , {v}_{n} ) ,$$

where n is the number of vectors, and d is the vector dimension;
a proximity graph constructing module, which is configured to construct a proximity graph G′ by using a method of incrementally adding vectors according to similarity distances between vectors in the vector data set and the hubness degree set H′;
a hubness degree set determining module, which is configured to perform vector hubness degree traversal calculation for the proximity graph G′ to obtain an updated hubness degree set H of all vectors, which is used to characterize a hubness neighbor relation of the proximity graph G′;
a final result proximity graph determining module, which is configured to perform a pruning operation on the proximity graph G′ based on the updated hubness degree set H of all vectors to obtain a final result proximity graph G;
a vector retrieval result determining module, which is configured to perform search on the final result proximity graph G by using a feature vector of a query object as a query vector, to obtain a vector retrieval result.

In a third aspect, the present disclosure provides a computer device, including a memory, a processor, and a computer program stored in the memory and executable on the processor, where the processor executes the computer program to implement the vector retrieval method based on the proximity graph.

According to the specific embodiment provided by the present disclosure, the present disclosure has the following technical effects.

The present disclosure provides a vector retrieval method based on a proximity graph and a device thereof. A hubness degree of each vector in a whole vector data set is determined by using an integral function of non-centrality chi-square distribution according to a vector data set, and then a quantitative index is provided for each vector to characterize its hubness feature. In this way, when constructing the proximity graph, the selected neighbor not only depends on an Euclidean distance, but also comprehensively takes into account the distribution features of data. A pruning operation is performed on the proximity graph G′ based on the updated hubness degree set H of all vectors to obtain a final result proximity graph G. The neighbor selection rules are dynamically adjusted to help to find more representative neighbors, thus forming a better proximity graph in the vector space. This effectively improves the global navigation performance, so that the retrieval result is more robust and reliable, the present disclosure can be adapted to different vector data sets and query scenes, and then the high adaptability enables the present disclosure to maintain a high performance in various application scenes.

### BRIEF DESCRIPTION OF THE DRAWINGS

In order to explain the technical scheme in the embodiments of the present disclosure or in the prior art more clearly, the drawings needed to be used in the embodiments will be briefly introduced hereinafter. Obviously, the drawings described below are only some embodiments of the present disclosure. For those skilled in the art, other drawings can be obtained according to these drawings without paying creative labor.

FIG. 1 is a flowchart of a vector retrieval method based on a proximity graph according to an embodiment of the present disclosure.

### DETAILED DESCRIPTION OF THE EMBODIMENTS

The technical scheme in the embodiments of the present disclosure will be clearly and completely described with reference to the drawings in the embodiment of the present disclosure hereinafter. Obviously, the described embodiments are only some embodiments of the present disclosure, rather than all of the embodiments. Based on the embodiments in the present disclosure, all other embodiments obtained by those skilled in the art without paying creative labor belong to the scope of protection of the present disclosure.

In order to enable the above objects, features and advantages of the present disclosure to be more obvious and understandable, the present disclosure will be further described in detail with reference to the drawings and the detailed description.

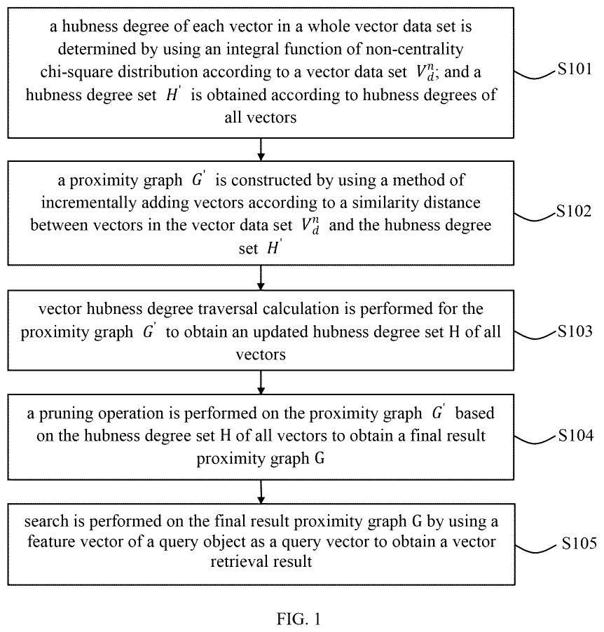

In an exemplary embodiment, as shown in FIG. 1, a vector retrieval method based on a proximity graph is provided. The method includes the following steps S101 to S105.

In S101, a hubness degree of each vector in a whole vector data set is determined by using an integral function of non-centrality chi-square distribution according to a vector data set

$${V}_{d}^{n} ;$$

and a hubness degree set H′ is obtained according to hubness degrees of all vectors; in which the vector data set is

$${V}_{d}^{n} = ( {v}_{1} , {v}_{2} , … , {v}_{n} ) ,$$

where n is the number of vectors, and d is the vector dimension.

S101 specifically includes the following steps S11-S15.

In S11, a mean center of the vector data set

$${V}_{d}^{n}$$

is acquired; where a mean center in the vector data set

$${V}_{d}^{n}$$

is v_{c}.

In S12, a distance distᵢ from an i-th vector vᵢ to the mean center v_{c} is determined.

In S13, an order Orderᵢ of the distances from all vectors to the mean center v_{c} is determined.

In S14, the order Orderᵢ is mapped to a meaningful value interval [xₘᵢₙ, xₘₐₓ] of the integral function of the non-centrality chi-square distribution with a degree of freedom d and a non-centrality parameter [symbol] to obtain a mapping value xᵢ.

In S15, the hubness degree hᵢ of each vector in the whole vector data set

$${V}_{d}^{n}$$

is determined by using the integral function of the non-centrality chi-square distribution according to the mapping value xᵢ, where hᵢ∈(0,1).

In S102, a proximity graph G′ is constructed by using a method of incrementally adding vectors according to a similarity distance between vectors in the vector data set

$${V}_{d}^{n}$$

and the hubness degree set H′.

S102 specifically includes the following steps 2.1-2.7.

In step 2.1, a vector corresponding to a maximum hubness degree in the hubness degree set H′ is set as an entry point E of the proximity graph.

In step 2.2, a current vector vⱼ to be inserted is acquired, search is performed on the proximity graph G′ under construction with the vector vⱼ as a query vector, an ordered candidate set queue M with a capacity of C is maintained, and the entry point E is inserted into the candidate set queue M.

In step 2.3, a vector vₓ in the candidate set queue M that is closest to the vector vᵢ and has not been accessed is selected, a neighbor vector set Neighbors(vₓ) of the vector vₓ is acquired, and the vector vₓ is marked as an accessed vector; each vector in the neighbor vector set Neighbors(vₓ) of the vector vₓ is added to the candidate set queue M, and the first C vectors in the candidate set queue M that is closest to the query vector vⱼ are retained.

In step 2.4, step 2.3 is repeated until all vectors in the candidate set queue M are accessed; and the current candidate set queue M is set as a candidate neighbor set Candidates₍ᵥ_{ⱼ}₎ of the current vector vⱼ to be inserted.

In step 2.5, a neighbor set Neighbors(vⱼ) of the current vector vⱼ to be inserted is determined by using a determination condition according to the candidate neighbor set; where a maximum capacity of the neighbor set Neighbors(vⱼ) is R, where R is a hyper-parameter for constructing a configuration of the proximity graph; and the determination condition is that both currently traversed candidate neighbor vector vₓ and any vector v′ inserted into the neighbor set satisfy:

$${α}_{k} * dist ( {v}_{k} , {v}^{′} ) \geq dist ( {v}_{i} , {v}_{k} ) ;$$

where αₖ is a relaxation parameter determined according to the hubness degree hₖ of the candidate neighbor vector vₖ, αₖ=1+α*hₖ, α is the hyper-parameter for constructing the configuration of the proximity graph, which is recommended to be set as 0.2, and dist is a similarity distance function.

In step 2.6, the neighbor set Neighbors(vⱼ) of the current vector vⱼ to be inserted is traversed, and the current vector vⱼ to be inserted is added to a neighbor set of each vector in the neighbor set Neighbors(vⱼ) in reverse; the maximum capacity of a neighbor set Neighbors(vₙ) after adding neighbors in reverse is enlarged to β*R; when the number of vectors in the neighbor set Neighbors(vₙ) is greater than the capacity β*R after reverse addition operation, a neighbor re-selection operation is executed, in which the candidate neighbor set Candidates₍ᵥ_{ₙ}₎ is a neighbor set Neighbors(vₙ) whose capacity is out of bounds, and β is a hyper-parameter for constructing the configuration of the proximity graph.

In step 2.7, steps 2.2 to 2.6 are repeated, so that all vectors are inserted into a current proximity graph to obtain the proximity graph G′.

In S103, vector hubness degree traversal calculation is performed for the proximity graph G′ to obtain an updated hubness degree set H of all vectors.

S103 specifically includes the following steps 3.1-3.4.

In Step 3.3, it is assumed that the number of vectors allocated to an i-th interval is sᵢ, and a data hubness degree of the vectors in the proximity graph G′ is determined by using an empirical cumulative distribution function.

In step 3.4, all the vectors are traversed to obtain an updated hubness degree set H, which is used to characterize a hubness neighbor relation of the proximity graph G′.

In step 3.1, the proximity graph G′ is traversed to count the number of times that each vector is selected as a neighbor for other vectors in the proximity graph G′, and the number of times is taken as an in-degree of the vector in the proximity graph G′, which is denoted as Hubnessᵢ.

In step 3.2, a range of the in-degree of all vectors is evenly divided into s intervals according to a minimum value of in-degrees Hubnessₘᵢₙ and a maximum value of in-degrees Hubnessₘₐₓ.

In step 3.3, it is assumed that the number of vectors allocated to an i-th interval is sᵢ, and a data hubness degree of each vector in the proximity graph G′ is determined by using an empirical cumulative distribution function:

$${F}_{n} ( {s}_{i} ) = \frac{1}{n} {\sum }_{j = 1}^{i} {s}_{j}$$

where data hubness of all vector data in the i-th interval is Fₙ(sᵢ).

In step 3.4, all the vectors are traversed to obtain the updated hubness degree set H, which is used to characterize a hubness neighbor relation of the proximity graph G′.

In S104, a pruning operation is performed on the proximity graph G′ based on the hubness degree set H of all vectors of the current proximity relation to obtain a final result proximity graph G.

S104 specifically includes:

performing a pruning operation on the proximity graph using the current proximity relation to obtain a final result proximity graph G; traversing all the vectors of the proximity graph G′, to reduce the capacity of the neighbor set of each vector from β*R to R.

In S105, search is performed on the final result proximity graph G by using a feature vector of a query object as a query vector to obtain a vector retrieval result.

S105 specifically includes the following steps 5.1-5.6.

In step 5.1, L vectors with the highest in-degree are determined according to the proximity graph G′, and the L vectors are set as a candidate set; the entry point E is taken as a search entry point, and γ*R neighbors are selected from the candidate set as an initial startup queue of a search; where γ is the relaxation parameter for search initialization.

In step 5.2, it is assumed that the query vector is q, an ordered candidate set queue SearchM with a capacity of SearchC is maintained, and the ordered candidate set queue SearchM is filled with the initial startup queue.

In step 5.3, the un-accessed vector vₓ that is closest to the query vector q is acquired from the ordered candidate set queue SearchM, a neighbor vector set Neighbors(vₓ) of the un-accessed vector vₓ is acquired, and the un-accessed vector vₓ is marked as the accessed vector.

In step 5.4, each neighbor vector in the neighbor vector set Neighbors(vₓ) is added to the ordered candidate set queue SearchM, and only the first SearchC vectors in the ordered candidate set queue SearchM that are closest to the query vector v are retained.

In step 5.5, step 5.3 and step 5.4 are repeated until all the vectors in the ordered candidate set queue SearchM are accessed.

In step 5.6, the first topK vectors in the ordered candidate set queue SearchM that are closest to the query vector q are set as a vector retrieval result, where topK≤SearchC.

The vector retrieval method based on the proximity graph provided by the present disclosure is described through specific embodiments. The acquired patent abstract data set is generated into corresponding vector data. The feature vector set of patent abstract data set is generated by a pre-training model. The text data of the patent abstract can be trained using the existing Bidirectional Encoder Representations from Transformer (BERT) model to extract features, which are then transformed into a vector data set

$${V}_{d}^{n}$$

corresponding to the features of the patent abstract. The vector dimension of the vector data set

$${V}_{d}^{n}$$

is d, and the number of vectors of the vector data set

$${V}_{d}^{n}$$

is n.

The data hubness degree of each vector data in the vector data set

$${V}_{d}^{n}$$

corresponding to the features of the patent abstract in the whole vector data set is calculated. The distances dist from all vector data v to the mean center v_{c} of the data set are calculated, and then are ordered. The order Orderᵢ of the distances distᵢ from the vector data vᵢ to the mean center v_{c} is mapped to a meaningful value interval [xₘᵢₙ, xₘₐₓ] of the integral function of the non-centrality chi-square distribution with a degree of freedom d and a non-centrality parameter [symbol] , to obtain a mapping value xᵢ. The hubness degree hᵢ of each vector in the whole vector data set is determined by using the integral function of the non-centrality chi-square distribution according to the mapping value xᵢ.

$${h}_{i} = f ( {x}_{i} ; v , ℓ ) = {e}^{- ℓ / 2} * {\sum }_{j = 0}^{∞} \frac{( ℓ / 2 ) !}{j !} f ( {x}_{i} ; v + 2 j )$$

where f(xᵢ; v+2j) is the integral function of the centrality chi-square distribution, hᵢ∈(0,1), ! is the factorial, and the hubness degree set H′ is:

$${H}^{′} = \{ {h}_{1} , {h}_{2} , … , {h}_{n} \}$$

According to the similarity of each vector in the feature vector set V of the patent abstract, the proximity graph G is constructed, and the similarity distance can be calculated by the Euclidean distance between vectors:

$$dist ( a ( {a}_{1} , {a}_{2} , … , {a}_{d} ) , b ( {b}_{1} , {b}_{2} , … , {b}_{d} ) ) = \sqrt{{\sum }_{i = 1}^{d} {( {a}_{i} - {b}_{i} )}^{2}}$$

where a and b are arbitrary d-dimensional vectors, aᵢ is an i-th component of the vector a, bᵢ is an i-th component of the vector b, and the dist function returns the similarity distance of the vectors a and b.

Further, the specific process of constructing the proximity graph G′ of the patent includes steps 1-14.

In step 1, the vector data with a maximum hubness degree hᵢ is selected as an entry point E of the proximity graph G′. Taking the entry point E as the starting point of constructing the proximity graph, the proximity graph G′ is constructed by using a method of incrementally adding vector data.

In step 2, a vector vⱼ to be inserted is selected from the feature vector set V of the patent, search is performed on the proximity graph under construction with the vector vⱼ as a query vector, an ordered candidate set queue M with the capacity of C is maintained, and the entry point E is inserted into the candidate set queue M.

In step 3, a point vₓ in the candidate set queue M that is closest to the vector vⱼ to be inserted and has not been accessed is selected, and a neighbor vector set Neighbors(vₓ) of the vector vₓ is acquired.

In step 4, each vector in Neighbors(vₓ) is added to the candidate set queue M, and only the first C vectors in the candidate set queue M that is closest to the vector vⱼ to be inserted is retained.

In step 5, step 3 and step 4 are repeated until there are no vectors in M that have not been accessed. The candidate set queue M obtained at this time is taken as the candidate neighbor set Candidates₍ᵥ_{ⱼ}₎ of the vector vⱼ to be inserted.

In step 6, it is assumed that the neighbor set of the vector vⱼ to be inserted is Neighbors(vⱼ), and its maximum capacity is R, where R is a hyper-parameter for constructing a configuration of the proximity graph; the neighbor candidate set queue is traversed in sequence, and only the candidate neighbors that satisfy the following conditions is added into the neighbor set: it is assumed that the currently traversed candidate neighbor vector is vₖ, and both vₖ and any vector v′ inserted into the neighbor set satisfy:

$${α}_{k} * d i s t ( {v}_{k} , {v}^{′} ) \geq d i s t ( {v}_{i} , {v}_{k} ) ;$$

where aₖ is a relaxation parameter determined according to the data hubness hₖ of the vector data vₖ, αₖ=1+α*hₖ, α is the hyper-parameter for constructing the configuration of the proximity graph, which is recommended to be set as 0.2, and dist is a similarity distance function.

In step 7, by traversing the neighbor set Neighbors(vᵢ) of the vector vⱼ to be inserted, vⱼ is added to the neighbor set of each vector vₙ in the neighbor set in reverse; the maximum capacity of the neighbor set Neighbors(vₙ) after adding neighbors in reverse is enlarged to β*R; when the number of vectors in the neighbor set Neighbors(vₙ) is greater than the capacity β*R after the reverse addition operation, a neighbor re-selection operation is executed, in which the candidate neighbor set Candidates₍ᵥ_{ₙ}₎ is a current neighbor set Neighbors(vₙ) whose capacity is out of bounds, and β is a hyper-parameter for constructing the configuration of the proximity graph.

In step 8, step 2 to step 7 are repeated, so that all vectors are inserted into the proximity graph to finally obtain the proximity graph G′ based on the vector data set of the patent.

In step 9, the proximity graph G′ is traversed, so that the number of times that each vector in the data set is selected as a neighbor for other vectors in the proximity graph is counted, that is, an in-degree of the vector in the proximity graph, which is denoted as Hubnessᵢ.

In step 10, a range of the in-degree of all vectors in the data set is evenly divided into s intervals according to Hubnessₘᵢₙ and Hubnessₘₐₓ.

It is assumed that the number of vectors allocated to an i-th interval is sᵢ, and the data hubness degree of the vectors in the proximity graph G′ is determined by using an empirical cumulative distribution function.

All the vectors are traversed to obtain the updated hubness degree set H, which is used to characterize a hubness neighbor relation of the proximity graph G′.

In step 11, it is assumed that the number of vectors allocated to an i-th interval is sᵢ, and the data hubness degree of the vectors in the proximity graph G′ is determined by using an empirical cumulative distribution function:

$${F}_{n} ( {s}_{i} ) = \frac{1}{n} {\sum }_{j = 1}^{i} {s}_{j}$$

where the data hubness of all vector data in the i-th interval is Fₙ(sᵢ). All the vectors in the data set are traversed to obtain their corresponding data hubnesses h and obtain the updated hubness degree set H, which is used to characterize a hubness neighbor relation of the proximity graph G′.

In step 12, a pruning operation is performed on the proximity graph using the updated hubness degree set H in the obtained vector data to obtain a final result proximity graph G. All the vectors vᵢ of the proximity graph G′ are traversed to reduce the capacity of the neighbor set Neighbors(vᵢ) of each vector from β*R to R, which is a process of re-selecting neighbors. At this time, the candidate neighbor set Candidates₍ᵥ_{ᵢ}₎ is a current neighbor set Neighbors(vᵢ) whose capacity is out of bounds.

In step 13, at this point, the proximity graph generation stage ends. That is, the proximity graph G can be used for query. First, the contents of the patent abstract to be queried are generated as a query object q, that is, the feature vector about the text data of the patent abstract to be queried generated by the pre-training model.

In step 14, after the generation of the feature vector of the patent abstract text to be queried is completed, the query vector q is used to query the proximity graph G based on the feature vector of the patent abstract to obtain topK feature vectors, and finally the topK patents approximate to the patent abstract text to be queried are returned.

The hubness degree of vectors is counted, so that neighbors that can better reflect the data distribution features can be selected in the process of constructing the proximity graph, thus reducing the situation of missing detection when performing search. Higher quality neighbor selection is based on the distribution features of the vector data set, so that the finally obtained proximity graph can better reflect the distribution features of vector data, and then the retrieval precision is improved. In the process of constructing the proximity graph, the hubness degree is used to relax or contract the neighbor selection properly, which can reduce unnecessary calculation, optimize the search process, effectively alleviate the common “dimension curse” problem in vector space, and thus improve the retrieval speed.

In an exemplary embodiment, there is provided a vector retrieval device based on a proximity graph, which includes:
a hubness degree determining module, which is configured to determine a hubness degree of each vector in a whole vector data set by using an integral function of non-centrality chi-square distribution according to a vector data set; and obtain a hubness degree set H′ according to hubness degrees of all vectors; where the vector data set is

$${V}_{d}^{n} = ( {v}_{1} , {v}_{2} , … , {v}_{n} ) ,$$

where n is the number of vectors, and d is the vector dimension which is used to characterize degree of freedom;
a proximity graph constructing module, which is configured to construct a proximity graph G′ by using a method of incrementally adding vectors according to similarity distances between vectors in the vector data set and the hubness degree set H′;
a hubness degree set determining module, which is configured to perform vector hubness degree traversal calculation for the proximity graph G′ to obtain an updated hubness degree set H of all vectors, which is used to characterize a hubness neighbor relation of the proximity graph G′;
a final result proximity graph determining module, which is configured to perform a pruning operation on the proximity graph G′ based on the updated hubness degree set H of all vectors of the current neighbor relation to obtain a final result proximity graph G;
a vector retrieval result determining module, which is configured to perform search on the final result proximity graph G by using a feature vector of a query object as a query vector, to obtain a vector retrieval result.

In an exemplary embodiment, a computer device is provided, which may be a server or a terminal. The computer device includes a processor, a memory, an Input/Output interface (I/O for short) and a communication interface.

In the present disclosure, all actions of acquiring signals, information or data are carried out under the premise of complying with the corresponding data protection laws and policies of the local country and obtaining authorization from the corresponding device owner.

The technical features of the above embodiments can be combined at will. In order to make the description concise, not all possible combinations of the technical features in the above embodiments are described. However, as long as there is no contradiction between the combinations of these technical features, the technical features should be considered as the scope described in this specification.

In the present disclosure, specific examples are used to illustrate the principle and the implementation of the present disclosure. The description of the above embodiments is only used to help understand the method and the core idea of the present disclosure. At the same time, for those skilled in the art, there will be changes in the detailed description and the application scope according to the idea of the present disclosure. In summary, the contents of this specification should not be construed as limiting the present disclosure.

What is claimed is:

1. A vector retrieval method based on a proximity graph, comprising:
determining a hubness degree of each vector in a whole vector data set by using an integral function of non-centrality chi-square distribution according to a vector data set; and obtaining a hubness degree set H′ according to hubness degrees of all vectors; wherein the vector data set is
$${V}_{d}^{n} = ( {v}_{1} , {v}_{2} , … , {v}_{n} ) ,$$
n is a number of vectors, and d is a vector dimension;
constructing a proximity graph G′ by using a method of incrementally adding vectors according to similarity distances between vectors in the vector data set and the hubness degree set H′;
performing vector hubness degree traversal calculation for the proximity graph G′ to obtain an updated hubness degree set H of all vectors;
performing a pruning operation on the proximity graph G′ based on the updated hubness degree set H of all vectors to obtain a final result proximity graph G;
performing search on the final result proximity graph G by using a feature vector of a query object as a query vector, to obtain a vector retrieval result.

2. The vector retrieval method based on the proximity graph according to claim 1, wherein the determining a hubness degree of each vector in a whole vector data set by using an integral function of non-centrality chi-square distribution according to a vector data set comprises:
acquiring a mean center of the vector data set
$${V}_{d}^{n} ;$$
wherein a mean center in the vector data set
$${V}_{d}^{n}$$
is v_{c};
determining a distance distᵢ from an i-th vector vᵢ to the mean center v_{c};
determining an order Orderᵢ of distances from all vectors to the mean center v_{c};
mapping the order Orderᵢ to a meaningful value interval of the integral function of the non-centrality chi-square distribution with a degree of freedom d and a non-centrality parameter [symbol] , to obtain a mapping value xᵢ;
determining the hubness degree hᵢ of each vector in the whole vector data set by using the integral function of the non-centrality chi-square distribution according to the mapping value xᵢ.

3. The vector retrieval method based on the proximity graph according to claim 1, wherein the constructing a proximity graph G′ by using a method of incrementally adding vectors according to similarity distances between vectors in the vector data set and the hubness degree set H′ comprises:
step 2.1, setting a vector corresponding to a maximum hubness degree in the hubness degree set H′ as an entry point E of the proximity graph;
step 2.2, acquiring a current vector vⱼ to be inserted, performing search on a proximity graph under construction with the vector vⱼ as a query vector, maintaining an ordered candidate set queue M with a capacity of C, and inserting the entry point E into the candidate set queue M;
step 2.3, selecting a vector vₓ in the candidate set queue M that is closest to the vector vⱼ and has not been accessed, acquiring a neighbor vector set Neighbors(vₓ)=(v₁, v₂, . . . , vᵣ) of the vector vₓ, and marking the vector vₓ as an accessed vector; adding each vector in the neighbor vector set Neighbors(vₓ) of the vector vₓ to the candidate set queue M, and retaining first C vectors in the candidate set queue M that is closest to the query vector vⱼ; wherein v₁ is a first neighbor vector of vₓ, and r is a number of neighbor vectors of vₓ;
step 2.4, repeating step 2.3 until all vectors in the candidate set queue M are accessed; and
setting a current candidate set queue M as the candidate neighbor set Candidates₍ᵥ_{ⱼ}₎ of the current vector vⱼ to be inserted;
step 2.5, determining a neighbor set Neighbors(vᵢ) of the current vector vⱼ to be inserted by using a determination condition according to the candidate neighbor set Candidates(vⱼ); wherein a maximum capacity of the neighbor set Neighbors(vⱼ) is R, R is a hyper-parameter for constructing a configuration of the proximity graph, and the determination condition is that both currently traversed candidate neighbor vector vₓ and any vector v′ inserted into the neighbor set satisfy:
$${α}_{k} * d i s t ( {v}_{k} , {v}^{′} ) \geq d i s t ( {v}_{i} , {v}_{k} ) ;$$
wherein αₖ is a relaxation parameter determined according to a hubness degree hₖ of a candidate neighbor vector vₖ, αₖ=1+α*hₖ, α is a hyper-parameter for constructing the configuration of the proximity graph, and dist is a similarity distance function;
step 2.6, traversing the neighbor set Neighbors(vⱼ) of the current vector vⱼ to be inserted, and adding the current vector vⱼ to be inserted to a neighbor set of each vector in the neighbor set Neighbors(vⱼ) in reverse; enlarging a maximum capacity of a neighbor set Neighbors(vₙ) after adding neighbors in reverse to β*R; when a number of vectors in the neighbor set Neighbors(vₙ) is greater than capacity β*R after reverse addition operation, executing a neighbor re-selection operation, in which a candidate neighbor set Candidates₍ᵥ_{ₙ}₎ is a current neighbor set Neighbors(vₙ) whose capacity is out of bounds, and β is a hyper-parameter for constructing the configuration of the proximity graph;
step 2.7, repeating step 2.2 to step 2.6, so that all vectors are inserted into a current proximity graph to obtain the proximity graph G′.

4. The vector retrieval method based on the proximity graph according to claim 1, wherein the performing vector hubness degree traversal calculation for the proximity graph G′ to obtain an updated hubness degree set H of all vectors comprises:
step 3.1, traversing the proximity graph G′ to count a number of times that each vector is selected as a neighbor for other vectors in the proximity graph G′, and setting the number of times as an in-degree of the vector in the proximity graph G′, which is denoted as Hubnessᵢ;
step 3.2, evenly dividing a range of in-degrees of all vectors into s intervals according to a minimum value of the in-degrees Hubnessₘᵢₙ and a maximum value of the in-degrees Hubnessₘₐₓ;
step 3.3, assuming that a number of vectors allocated to an i-th interval is sᵢ, and determining a hubness degree of each vector in the proximity graph G′ by using an empirical cumulative distribution function;
step 3.4, traversing all the vectors to obtain the updated hubness degree set H, which is used to characterize a hubness neighbor relation of the proximity graph G′.

5. The vector retrieval method based on the proximity graph according to claim 4, wherein the performing search on the final result proximity graph G by using a feature vector of a query object as a query vector, to obtain a vector retrieval result, comprises:
step 5.1, determining L vectors with a highest in-degree according to the final result proximity graph G, and setting the L vectors as a candidate set; setting the entry point E as the entry point, and selecting γ*R neighbors from the candidate set as an initial startup queue of a search; where γ is a relaxation parameter for search initialization;
step 5.2, assuming that the query vector is q, maintaining an ordered candidate set queue SearchM with a capacity of SearchC, and filling the ordered candidate set queue SearchM with the initial startup queue;
step 5.3, acquiring an un-accessed vector vₓ that is closest to the query vector q from the ordered candidate set queue SearchM, acquiring a neighbor vector set Neighbors(vₓ) of the un-accessed vector vₓ, and marking the un-accessed vector vₓ as an accessed vector;
step 5.4, adding each neighbor vector in the neighbor vector set Neighbors(vₓ) to the ordered candidate set queue SearchM, and retaining only first SearchC vectors in the ordered candidate set queue SearchM that are closest to the query vector q;
step 5.5, repeating step 5.3 and step 5.4 until all the vectors in the ordered candidate set queue SearchM are accessed;
step 5.6, setting first topK vectors in the ordered candidate set queue SearchM that are closest to the query vector q as a vector retrieval result, where topK≤SearchC.

6. A vector retrieval device based on a proximity graph, comprising:
a hubness degree determining module, which is configured to determine a hubness degree of each vector in a whole vector data set by using an integral function of non-centrality chi-square distribution according to a vector data set; and obtain a hubness degree set H′ according to hubness degrees of all vectors; wherein the vector data set is
$${V}_{d}^{n} = ( {v}_{1} , {v}_{2} , … , {v}_{n} ) ,$$
n is a number of vectors, and d is a vector dimension;
a proximity graph constructing module, which is configured to construct a proximity graph G′ by using a method of incrementally adding vectors according to similarity distances between vectors in the vector data set and the hubness degree set H′;
a hubness degree set determining module, which is configured to perform vector hubness degree traversal calculation for the proximity graph G′ to obtain an updated hubness degree set H of all vectors, which is used to characterize a hubness neighbor relation of the proximity graph G′;
a final result proximity graph determining module, which is configured to perform a pruning operation on the proximity graph G′ based on the updated hubness degree set H of all vectors to obtain a final result proximity graph G;
a vector retrieval result determining module, which is configured to perform search on the final result proximity graph G by using a feature vector of a query object as a query vector, to obtain a vector retrieval result.

7. A computer device, comprising a memory, a processor, and a computer program stored in the memory and executable on the processor, wherein the processor executes the computer program to implement the vector retrieval method based on the proximity graph according to claim 1.

8. The computer device according to claim 7, wherein the processor executes the computer program for:
acquiring a mean center of the vector data set
$${V}_{d}^{n} ;$$
wherein a mean center in the vector data set
$${V}_{d}^{n}$$
is v_{c};
determining a distance distᵢ from an i-th vector vᵢ to the mean center v_{c};
determining an order Orderᵢ of distances from all vectors to the mean center v_{c};
mapping the order Orderᵢ to a meaningful value interval of the integral function of the non-centrality chi-square distribution with a degree of freedom d and a non-centrality parameter [symbol] , to obtain a mapping value xᵢ;
determining the hubness degree hᵢ of each vector in the whole vector data set by using the integral function of the non-centrality chi-square distribution according to the mapping value xᵢ.

9. The computer device according to claim 7, wherein the processor executes the computer program for:
step 2.1, setting a vector corresponding to a maximum hubness degree in the hubness degree set H′ as an entry point E of the proximity graph;
step 2.2, acquiring a current vector vⱼ to be inserted, performing search on a proximity graph under construction with the vector vⱼ as a query vector, maintaining an ordered candidate set queue M with a capacity of C, and inserting the entry point E into the candidate set queue M;
step 2.3, selecting a vector vₓ in the candidate set queue M that is closest to the vector vⱼ and has not been accessed, acquiring a neighbor vector set Neighbors(vₓ)=(v₁, v₂, . . . , vᵣ) of the vector vₓ, and marking the vector vₓ as an accessed vector; adding each vector in the neighbor vector set Neighbors(vₓ) of the vector vₓ to the candidate set queue M, and retaining first C vectors in the candidate set queue M that is closest to the query vector vⱼ; wherein v₁ is a first neighbor vector of vₓ, and r is a number of neighbor vectors of vₓ;
step 2.4, repeating step 2.3 until all vectors in the candidate set queue M are accessed; and setting a current candidate set queue M as the candidate neighbor set Candidates₍ᵥ_{ⱼ}₎ of the current vector vⱼ to be inserted;
step 2.5, determining a neighbor set Neighbors(vⱼ) of the current vector vⱼ to be inserted by using a determination condition according to the candidate neighbor set Candidates₍ᵥ_{ⱼ}₎; wherein a maximum capacity of the neighbor set Neighbors(vⱼ) is R, R is a hyper-parameter for constructing a configuration of the proximity graph, and the determination condition is that both currently traversed candidate neighbor vector vₓ and any vector v′ inserted into the neighbor set satisfy:
$${α}_{k} * d i s t ( {v}_{k} , {v}^{′} ) \geq d i s t ( {v}_{i} , {v}_{k} ) ;$$
wherein αₖ is a relaxation parameter determined according to a hubness degree hₖ of a candidate neighbor vector vₖ, αₖ=1+α*hₖ, α is a hyper-parameter for constructing the configuration of the proximity graph, and dist is a similarity distance function;
step 2.6, traversing the neighbor set Neighbors(vⱼ) of the current vector vⱼ to be inserted, and adding the current vector vⱼ to be inserted to a neighbor set of each vector in the neighbor set Neighbors(vⱼ) in reverse; enlarging a maximum capacity of a neighbor set Neighbors(vₙ) after adding neighbors in reverse to β*R; when a number of vectors in the in neighbor set Neighbors(vₙ) is greater than capacity β*R after reverse addition operation, executing a neighbor re-selection operation, in which a candidate neighbor set Candidates₍ᵥ_{ₙ}₎ is a current neighbor set Neighbors(vₙ) whose capacity is out of bounds, and β is a hyper-parameter for constructing the configuration of the proximity graph;
step 2.7, repeating step 2.2 to step 2.6, so that all vectors are inserted into a current proximity graph to obtain the proximity graph G′.

10. The computer device according to claim 7, wherein the processor executes the computer program for:
step 3.1, traversing the proximity graph G′ to count a number of times that each vector is selected as a neighbor for other vectors in the proximity graph G′, and setting the number of times as an in-degree of the vector in the proximity graph G′, which is denoted as Hubnessᵢ;
step 3.2, evenly dividing a range of in-degrees of all vectors into s intervals according to a minimum value of the in-degrees Hubnessₘᵢₙ and a maximum value of the in-degrees Hubnessₘₐₓ;
step 3.3, assuming that a number of vectors allocated to an i-th interval is sᵢ, and determining a hubness degree of each vector in the proximity graph G′ by using an empirical cumulative distribution function;
step 3.4, traversing all the vectors to obtain the updated hubness degree set H, which is used to characterize a hubness neighbor relation of the proximity graph G′.

11. The computer device according to claim 10, wherein the processor executes the computer program for:
step 5.1, determining L vectors with a highest in-degree according to the final result proximity graph G, and setting the L vectors as a candidate set; setting the entry point E as the entry point, and selecting γ*R neighbors from the candidate set as an initial startup queue of a search; where γ is a relaxation parameter for search initialization;
step 5.2, assuming that the query vector is q, maintaining an ordered candidate set queue SearchM with a capacity of SearchC, and filling the ordered candidate set queue SearchM with the initial startup queue;
step 5.3, acquiring an un-accessed vector vₓ that is closest to the query vector q from the ordered candidate set queue SearchM, acquiring a neighbor vector set Neighbors(vₓ) of the un-accessed vector vₓ, and marking the un-accessed vector vₓ as an accessed vector;
step 5.4, adding each neighbor vector in the neighbor vector set Neighbors(vₓ) to the ordered candidate set queue SearchM, and retaining only first SearchC vectors in the ordered candidate set queue SearchM that are closest to the query vector q;
step 5.5, repeating step 5.3 and step 5.4 until all the vectors in the ordered candidate set queue SearchM are accessed;
step 5.6, setting first topK vectors in the ordered candidate set queue SearchM that are closest to the query vector q as a vector retrieval result, where topK≤SearchC.
